(19) United States
(12) Patent Application Publication
(10) Pub. No.: US 2007/0062982 A1
(43) Pub. Date: Mar. 22, 2007

(54) Container with a device to discharge product

(76) Inventors: Thorsten Blum, Darmstadt (DE); Stefan Hopp, Ingelheim (DE); Ronald Wienziers, Heusenstamm (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/418,636

(22) Filed: May 5, 2006

(30) Foreign Application Priority Data
May 6, 2005 (DE) 202005007204.4

(51) Int. Cl. B67D 3/00; B22D 37/00

(52) U.S. Cl. 222/518; 222/509

(57) ABSTRACT

In order to enable the removal of any quantity of product with a container (1) with a device (2) to discharge product, particularly trickling or free-flowing product, with a reservoir (3) to hold the product, a product discharge opening (4), and a connection (5) between the reservoir (3) and the device (2), it is proposed that the container (1) have a channel (6), which is provided for routing the product from the reservoir (3) up to the product discharge opening (4), that the device (2) have a closure part (10) for optional sealing and releasing of the outlet (7) of the channel (6), and that the closure part (10) be movable towards or away from the outlet (7) using a slide mechanism (14).

The object of the invention relates to a container to discharge product, particularly to provide granulate in the hair salon industry.

Granulate-type hair treatment agent is used in hair salons. Said treatment agent should be manually removable from a container in a simple manner, wherein the use of one of the user's hands should be sufficient to remove the product so that the user has the other hand available for a different function.

A container according to the preamble of Claim 1 is known from DE 34 38 677 A1. This container with a device to discharge product has a reservoir to hold the product, a product discharge opening is used for product exiting, and a connection between the reservoir and the device serves to provide a one-piece design of the container.

The known container has the disadvantage that only one predetermined volumed quantity of product can be discharged from the releasing device. The removal of a user-defined quantity is not possible.

The object was to further develop the object according to the preamble of Claim 1, which would overcome this disadvantage.

The object is achieved according to the distinguishing component of Claim 1. Accordingly, the container has a channel, which is provided to route the product from the reservoir up to the product discharge opening, the device has a closure part for optional sealing and releasing of an outlet of the channel, and the closure part can be moved towards and away from the outlet using a slide mechanism.

The suggested container has the advantage that any desired product quantity can be removed. A user can allow a product stream to flow out of the product discharge opening by actuating, from time to time, the slide mechanism provided for product outlet. In this process, the user is the one that determines the duration of the product output stream for any desired product quantity. The container can be used with one hand in a simple manner. The slide mechanism ensures the opening and closing of the outlet.

Advantageous embodiments of the container according to the invention are described in Claims 2 through 6.

When the container is arranged upside down, the product contained in the reservoir is only dispensed while the actuation device is being activated, if, according to Claim 2, the slide mechanism has an actuation device, which is connected to the closure part via a brace and a cross brace. Then, use of the slide mechanism causes the closure part to be placed into or taken out of the outlet. If the cross brace is spring-loaded using a spring opposite the brace or the actuation device, a secure closure of the outlet is achieved as a result of the compensating effect of the spring, even with an imprecise slide position. For the purposes of achieving a good seal of the outlet, is also advantageous if the closure part has a conical shape and the outlet is round (Claim 3).

A channel, which narrows in the shape of a funnel from the connection to the outlet (Claim 4), routes the product streaming out of the reservoir precisely to the outlet.

If the container has a longitudinally extended shape according to Claim 5, on one end of which the product discharge opening is provided, said container can be grasped like a pen and held. For easier holding, even with wet hands, particularly in the hair salon industry, it is advantageous if a container expansion is provided on the end of the container that is opposite the product discharge opening (Claim 6).

The invention is described in detail below with reference to figures that show an exemplary embodiment. The following is shown:

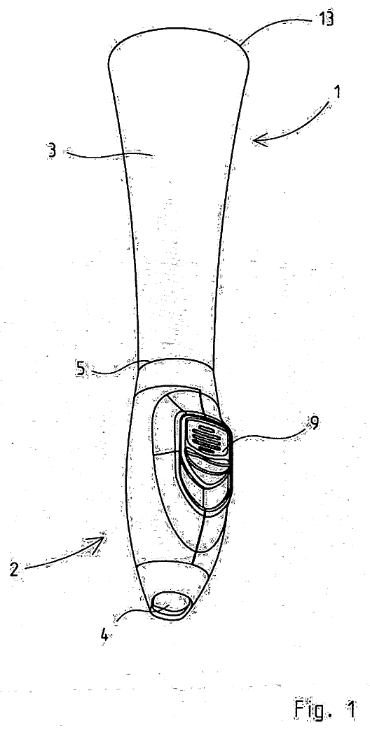

FIG. 1 shows a perspective view of a container with an actuator device designed as an actuation knob to discharge free-flowing product;

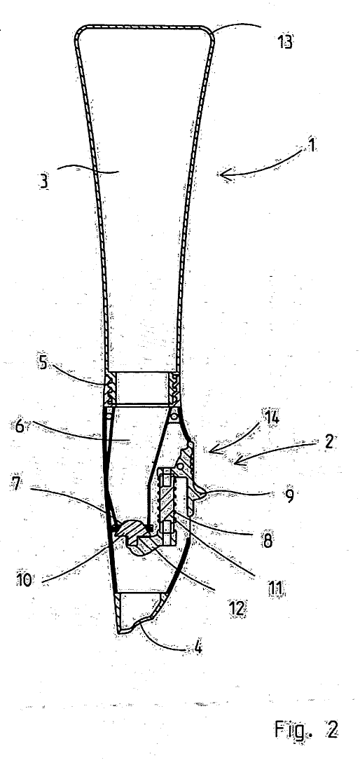

FIG. 2 shows a cut-out of the container according to FIG. 1 with the actuator device not being pressed and thereby with a closed channel; and

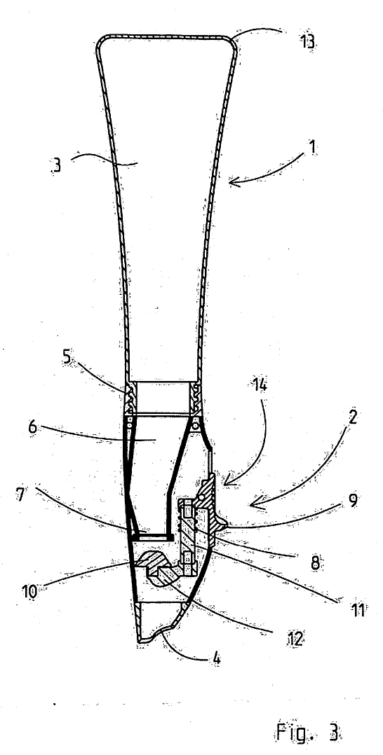

FIG. 3 shows a cut-out of the object according to FIG. 2, but with the actuator device being pressed and thereby a free channel for product discharge.

A container 1 (FIG. 1) has a device 2 to discharge product, particularly trickling or free-flowing product, with a reservoir 3 to hold the product, and a product discharge opening 4 has a connection 5 between the reservoir 3 and the device 2, which is executed as a screw connection. The container 1 has a channel 6, which is provided for routing the product from the reservoir 3 up to the product discharge opening 4.

The device 2 has a conical closure part 10 to optionally seal off and release a round outlet 7 of the channel 6. The closure part 10 can be moved towards and away from the outlet 7 (FIG. 2) using a slide mechanism 14 (FIG. 3). The slide mechanism 14 has an actuation device 9, which can be connected to the closure part 10 via a detachable brace 11 and a detachable cross brace 12. The cross brace 12 is spring-loaded using a spring 8 as a tension spring, which is opposite the actuation device 9. The channel 6 narrows from the connection 5 up to the outlet 7 in a funnel-shaped design.

The container 1 is held downwards in order to dispense the product with the product discharge opening 4, wherein product flows from the reservoir 3 through the funnel-shaped channel 6. A container expansion 13 is provided, on the end of the longitudinally extended container 1 that is opposite the product discharge opening 4, for improving manually holding the container 1, which can be used with one hand.

### REFERENCE LIST

1 Container
2 Device to discharge product
3 Reservoir
4 Product discharge opening
5 Connection
6 Channel
7 Outlet
8 Spring
9 Actuator device
10 Closure part
11 Brace
12 Cross brace
13 Container expansion
14 Slide mechanism

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container (1) comprising a device (2) to discharge product, particularly trickling or free-flowing product, comprising a reservoir (3), a product discharge opening (4), and a connection (5) between the reservoir (3) and the device (2), wherein the container (1) comprises a channel (6), which is provided for routing the product from the reservoir (3) up to the product discharge opening (4), the device (2) comprises a closure part (10) for optional sealing and releasing of the outlet (7) of the channel (6), and the closure part (10) can be moved towards or away from the outlet (7) using a slide mechanism (14).

2. A container according to claim 1, wherein the slide mechanism (14) comprises an actuation device (9), which is connected to the closure part (10) via a brace (11) and a cross brace (12), and wherein the cross brace (12) is preferably spring-loaded using a spring (8) opposite the brace (11) or the actuation device (9).

3. A container according to claim 1, wherein the closure part (10) is a conical shape and the outlet (7) is round.

4. A container according to claim 1, wherein the channel (6) narrows in the shape of a funnel from the connection (5) up to the outlet (7).

5. A container according to claim 1, wherein the container (1) is a longitudinally extended shape, on one end of which the product discharge opening (4) is provided.

6. A container according to claim 5, wherein a container expansion (13) is provided on the opposite end.
